(19) United States
(12) Patent Application Publication
(10) Pub. No.: US 2019/0001358 A1
(43) Pub. Date: Jan. 3, 2019

(54) ADJUSTABLE STROKE DISPENSER

(71) Applicant: RIEKE PACKAGING SYSTEMS LIMITED, LEICESTERSHIRE (GB)

(72) Inventor: Yen Kean LEE, Rohnert Park, CA (US)

(21) Appl. No.: 16/062,758

(22) PCT Filed: Dec. 16, 2016
(86) PCT No.: PCT/EP2016/081509

§ 371 Date: Jun. 15, 2018

Related U.S. Application Data
(60) Provisional application No. 62/268,176, filed on Dec. 16, 2015.

(51) Int. Cl. B05B 11/00

(52) U.S. Cl. CPC B05B 11/3008; B05B 11/3087

(57) ABSTRACT

A flowable product dispenser has a movable actuator (24) whose stroke length, represented by axial travel, corresponds to the product dosage which is dispensed. An adjustable ring (26) is fitted to a portion of the actuator wherein the position of the ring on the actuator determines the stroke length. This adjustable stroke feature allows the user of the dispenser to select a desired dosage within a dosage range for the particular dispenser.

### BACKGROUND

One type or style of dispenser for a flowable product includes a pump mechanism or arrangement which is typically manually actuated by the user. The manner of manual actuation of the pump arrangement may take on various forms, with the two most common forms being (1) axial travel (i.e. stroke) of an actuator and (2) using a squeeze container as the means for pressurization. In each form of manual actuation there is an elevated or increased pressure created within some portion of the pump arrangement which causes a dosage of the flowable product placed within the container to be dispensed from an outlet nozzle of the actuator.

In the first mentioned form of actuation, the axial travel of the actuator component causes pressurizing of a pump chamber which results in dispensing a dosage of product. The product being dispensed may have a foam consistency. However, the present invention is fully applicable as a design improvement to any type of dispenser which actuates or dispenses with a piston stroke, regardless of the orientation. Trigger sprayers would be another option for the present invention.

In the second mentioned form of actuation, the squeezing of the container (i.e. a flexible container) causes the product within the container to flow in the direction of the dispensing outlet. When a foam product is being dispensed the liquid within the container is mixed with air as it travels through the pump arrangement in the direction of the dispensing outlet. Temporarily reducing the volume of the container in this manner by squeezing inwardly on the container wall affects both the space occupied by the liquid product within the container and the space occupied by air in the headspace above the liquid product and in any air chamber within the pump arrangement.

With a squeeze container it would be possible to influence the dosage amount of product being dispensed simply by the level or degree of compression or squeezing of the flexible container. However, the issues here are the repeatability and predictability of a dosage amount. Since the compression or squeezing of the flexible container is not something which can be precisely controlled for any desired repeatability, it would be difficult to control the desired dosage since the overall process of using a squeeze dispenser is not calibrated for repeatability. There simply is no precise measure nor any realistic way to control or calibrate how much squeezing force is applied or needs to be applied for a desired dosage. Further, the dosage for the same squeezing force should vary as the ratio of liquid product and air left within the container changes as each successive dosage of product is dispensed.

With a pump dispenser, such as the type used to dispense a product with a foam consistency, the stroke length or axial travel of the actuator from a normally up position to a depressed position typically determines the dosage of product being dispensed. These types of actuator-controlled pump dispensers can be precisely designed and the sizing and construction of the component parts can also be precisely designed and controlled. This level of design control allows the dispenser to be tailored for a specific product wherein the intended dosage is defined based on a full stroke of the actuator. Once the dispenser is designed, the stroke length is typically set and correspondingly the resulting dosage from that stroke length is set.

The dosage preference from a pump dispenser is subjective with individual consumers. Even for the same product, such as a liquid foaming hand soap, some consumers may prefer having a larger dosage than the “factory setting” while other consumers may prefer having a smaller dosage than the “factory setting”. As such, it would be an improvement for this type of flowable product dispenser to enable each consumer to “dial in” a desired dosage within a designed dosage range. Assuming that the so-termed “factory setting” is at the midpoint of the range, as one example, the designed range would enable selection of a higher dosage amount compared to the midpoint or selection of a lower dosage amount compared to the midpoint. Another option would be to establish the “factory setting” at one of the two dosage extremes, such as the maximum dosage at one extreme or the minimum dosage at the other extreme and allow the customer to adjust accordingly. Obviously in these situations where the “factory setting” is at one end point or the other, the adjustments from the maximum setting are all in the direction of lower settings while the adjustments for the lowest setting are all in the direction of higher settings.

### SUMMARY

The exemplary embodiments of the present invention provide a dispenser for a flowable product with an axially movable actuator which has an adjustable stroke. The stroke length (i.e. axial travel) is adjustable such that the corresponding dosage, for a full stroke, which is dispensed is adjustable. The length of axial stroke travel normally determines the dosage of product to be dispensed. The actual dosage amount is influenced by the design, sizing and arrangement of the pump components. These pump components define what would be the “factory setting” dosage. The adjustment feature which is provided by the disclosed embodiments creates a dosage range between a minimum setting and a maximum setting. The so-termed “factory setting” may be a midpoint setting between the minimum setting and maximum setting or that “factory setting” could be either the minimum setting or the maximum setting or even at some other intermediate position. The point to be stressed is that the disclosed embodiments provide a stroke adjustment feature which allows the end user to selectively decide on the desired dosage within a defined dosage range.

The issue being addressed is that the normal “factory setting” assumes a “one dosage fits all” marketing strategy. What has been learned is that consumers prefer to have some variation in that dosage amount. The exemplary embodiments of the present invention focus on a simple, reliable and repeatable construction which enables the end user to select a desired dosage amount within a dosage range. This dosage selection feature can be either infinitely variable such as by the use of threaded engagement or adjusted in incremental steps such as by detent engagement. This detent engagement could also, alternatively, be in the form of ratchet tooth engagement for establishing incremental step adjustments. In terms of the actuator stroke length being discussed, this is full travel of the actuator to a point of abutment, as described herein, rather than some type of shortened or partial stroke.

The disclosed constructions for the exemplary embodiments provide the improvement mentioned in the Background.

Further forms, objects, features, aspects, benefits, advantages, and embodiments of the present invention will become apparent from a detailed description and drawings provided herewith.

### BRIEF DESCRIPTION OF THE DRAWINGS

FIG. 1 is a side elevational, cross-sectional view of a dispensing system incorporating a dispenser according to the present invention.

FIG. 2 is a side elevational, cross-sectional view of the FIG. 1 dispensing system with an adjusted stroke length.

FIG. 3 is a side elevational, cross-sectional view of the FIG. 1 dispensing system with an adjusted stroke length.

FIG. 4 is an exploded perspective view of the FIG. 1 dispenser.

FIG. 5 is an exploded elevational view of the FIG. 1 dispenser.

FIG. 6 is a side elevational view of an actuator which comprises part of the FIG. 1 dispenser.

FIG. 7 is a front elevational view of the FIG. 6 actuator.

FIG. 8 is a side elevational view, in full section, of the FIG. 6 actuator.

FIG. 9 is a perspective view of the FIG. 6 actuator.

FIG. 10 is a top plan view of the FIG. 6 actuator.

FIG. 11 is a perspective view of a ring which comprises part of the FIG. 1 dispenser.

FIG. 12 is a perspective view of the FIG. 11 ring.

FIG. 13 is a top plan view of the FIG. 11 ring.

FIG. 14 is a front elevational view, in full section, of the FIG. 11 ring.

FIG. 15 is a partial perspective view of the FIG. 11 ring.

FIG. 16 is a front elevational view of a closure which comprises part of the FIG. 1 dispenser.

FIG. 17 is a perspective view of the FIG. 16 closure.

FIG. 18 is a perspective view of the FIG. 16 closure.

FIG. 19 is a front elevational view, in full section, of the FIG. 16 closure.

FIG. 20 is a partial perspective view of the FIG. 16 closure.

FIG. 21 is a perspective view of a dispenser according to another embodiment of the present invention.

FIG. 22 is a perspective view of the FIG. 21 dispenser.

FIG. 23 is a side elevational view of the FIG. 21 dispenser.

FIG. 24 is a side elevational view, in full section, of the FIG. 21 dispenser with an actuator stroke adjusted for a first dosage.

FIG. 25 is a side elevational view, in full section, of the FIG. 21 dispenser with an actuator stroke adjusted for a second dosage.

FIG. 26 is a side elevational view, in full section, of the FIG. 21 dispenser with an actuator stroke adjusted for a third dosage.

FIG. 27 is a side elevational view, in full section, of the FIG. 21 dispenser with an actuator stroke adjusted for a fourth dosage.

FIG. 28 is this perspective view of a ring which comprises part of the FIG. 21 dispenser.

FIG. 29 is a perspective view of an actuator which comprises part of the FIG. 21 dispenser.

FIG. 30 is a partial, diagrammatic, front elevational view, in full section, of an alternative fixed engagement arrangement for the disclosed dispensers involving ratchet tooth engagement.

### DESCRIPTION OF THE SELECTED EMBODIMENTS

For the purpose of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates. One embodiment of the invention is shown in great detail, although it will be apparent to those skilled in the relevant art that some features that are not relevant to the present invention may not be shown for the sake of clarity.

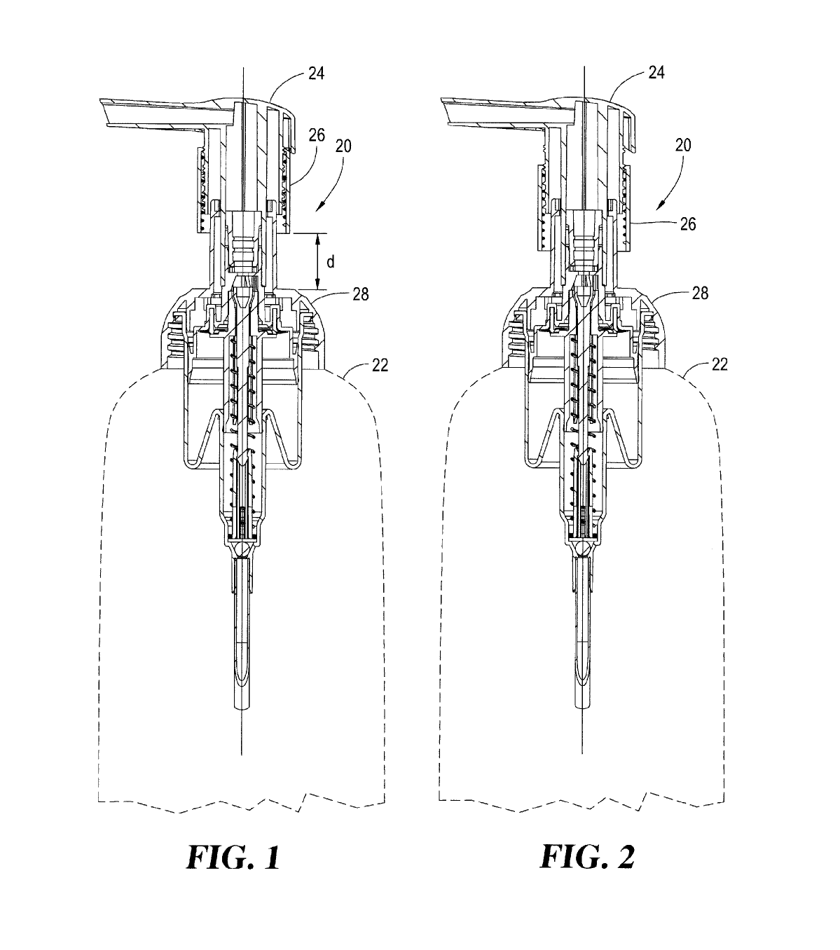

Referring to FIGS. 1 through 5, there is illustrated a dispenser 20 which is constructed and arranged for assembly to a container 22 for the dispensing of a dosage of a flowable product. The dosage dispensed is directly related to the axial travel (i.e. stroke length) of the actuator. Dispenser 20 is constructed and arranged according to one embodiment of the present invention. The assembly of dispenser 20 to container 22 creates a dispensing system for the flowable product which is placed in the container. In one version of the exemplary embodiment the flowable product is a foaming liquid for mixing with air within dispenser 20, followed by aeration in order to dispense the product with a foam consistency.

It is conceivable that the design of dispenser 20 could change depending on the specifics of container 22 and/or the specific product to be dispensed. It is also recognized that the sizing of the pump components which are used as part of dispenser 20 may be changed depending on the dosage range which is desired. A larger pump arrangement as part of dispenser 20 with larger liquid and air chambers would presumably change the dosage range and this decision likely involves a consideration of the type of product. Assuming that the desired dosage range changes depending on the product to be dispensed, the present invention contemplates in one embodiment that the factory setting for the dosage will be a mid-range dosage which is set based on historical data regarding consumer preferences. However, the disclosed exemplary embodiments of dispenser 20 and of dispenser 120 are constructed and arranged to provide an adjustable dosage so that the consumer can select a dosage which is different from the factory setting. If the factory setting is a mid-range dosage, then the disclosed exemplary embodiments allow the consumer to “dial in” a larger dosage from that factory setting or a smaller dosage from that factory setting. It is also envisioned as part of the disclosed exemplary embodiments that the factory setting might be a dosage at the upper limit or could be a dosage at the lower limit. In those instances, the adjustment which is made would be to select a smaller dosage from that upper limit or in the other case select a larger dosage from that lower limit.

With continued reference to FIGS. 1 through 5, dispenser 20 includes actuator 24, ring 26, closure 28, mesh insert 30, air piston 32, diaphragm 34, gasket 36, liquid piston 38, pull stick 40, spring 42, spring stem 44, ball 46, housing 48 and dip tube 50. With the exception of actuator 24 and ring 26, the remaining component parts are envisioned as comprising a pump arrangement of dispenser 20 wherein this pump arrangement is engaged or actuated by movement of actuator 24. The function of ring 26, as will be described herein, is to adjust or vary the actuator stroke length so that the dosage which is dispensed can be selected by the end user based on where the ring 26 is positioned relative to the actuator 24 and accordingly relative to closure 28.

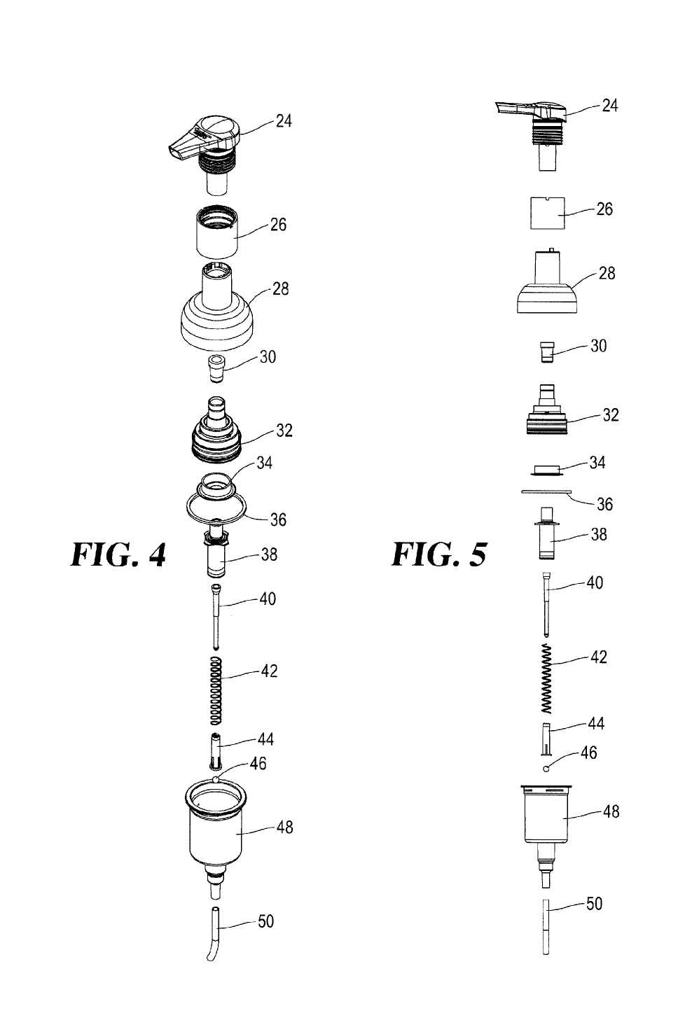

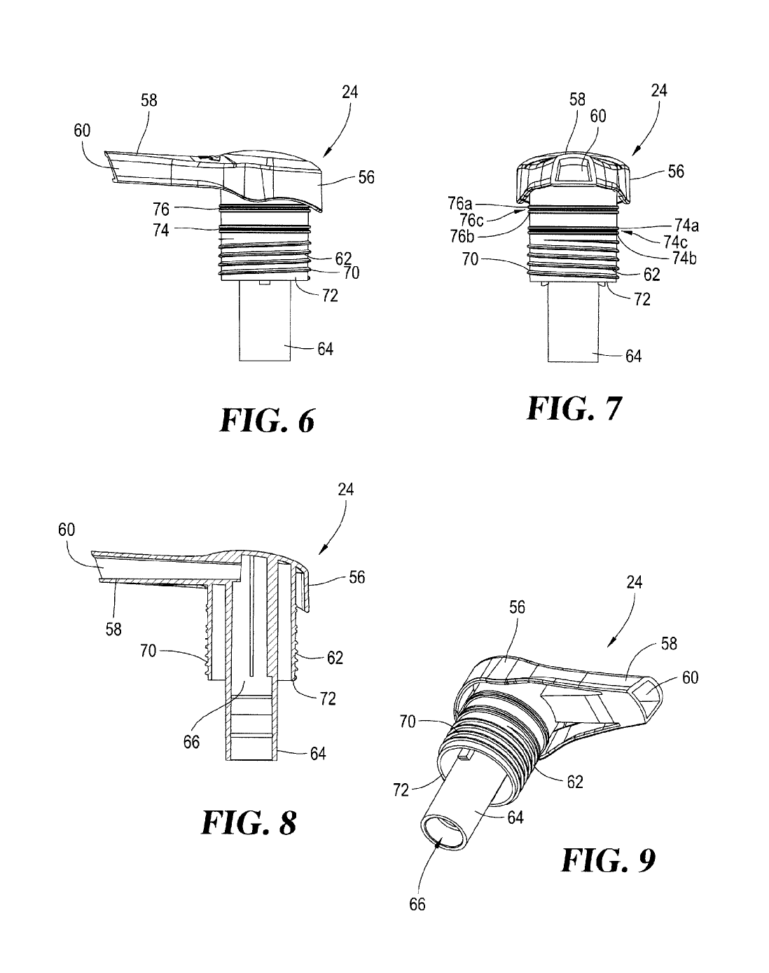

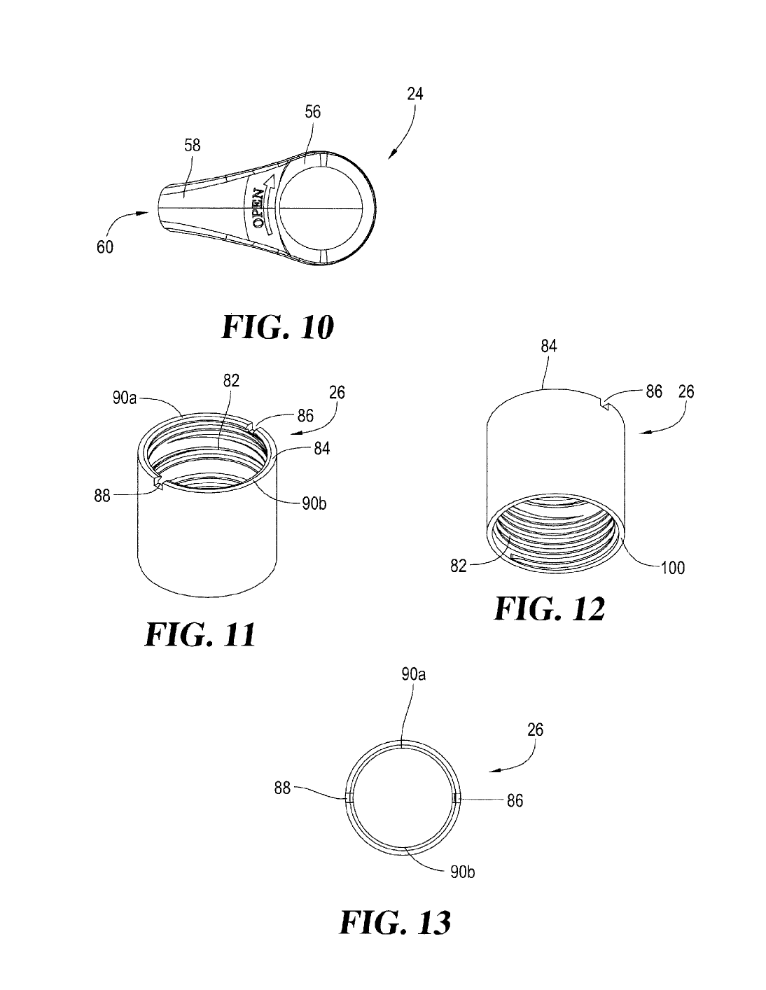

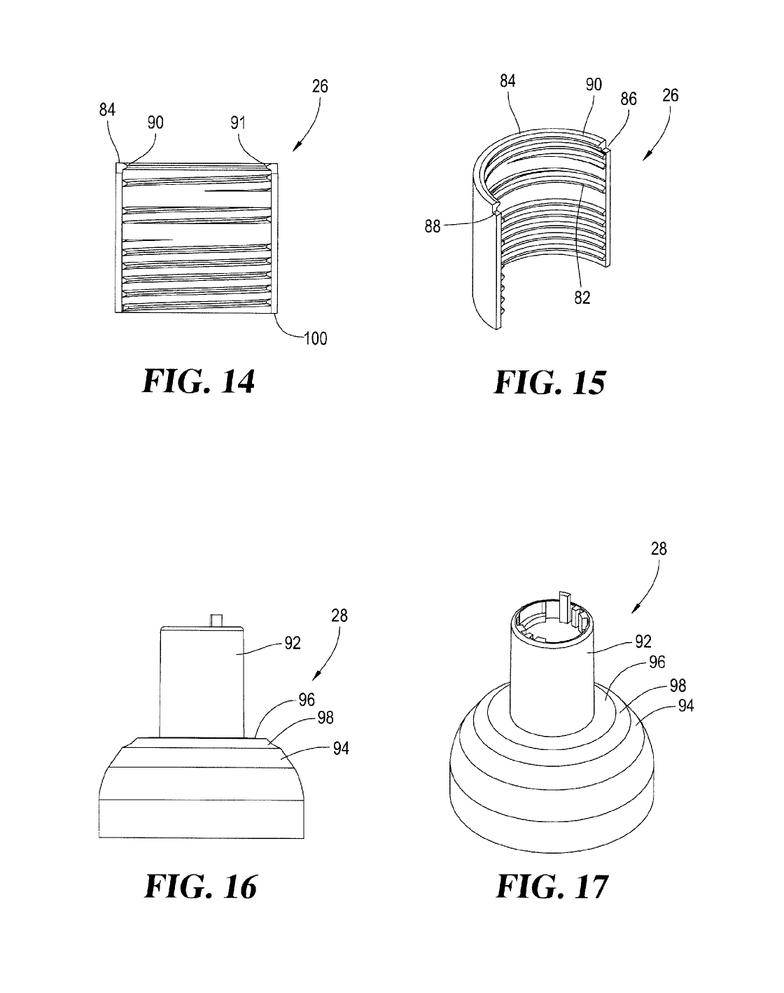

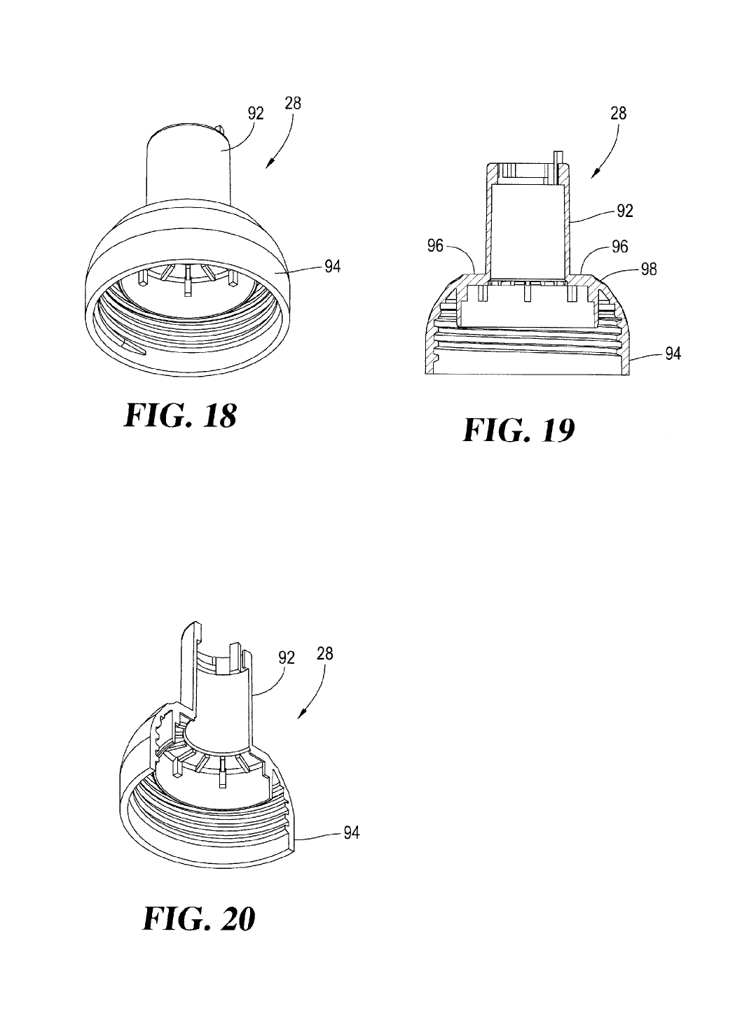

FIGS. 1 through 3 show the various component parts of dispenser 20 as assembled into and comprising dispenser 20. FIGS. 4 and 5 each show these component parts as an exploded view. With the exception of actuator 24 and ring 26, the identified component parts perform and operate in what would be regarded and understood as the normal manner for pump dispensers or pump arrangements with a dual piston construction (air and liquid) for dispensing the liquid product contained in container 22 with a foam consistency. Manual actuation of the actuator 24 in an axial direction toward closure 28 creates a pressurization of the spaces or volumes within the dispenser resulting in a pumping action. As a dosage of liquid product is delivered to a mixing chamber, a volume of air is also delivered and this liquid-air mixture is pushed through a mesh for aeration and the production of foam. The foam dosage is then delivered to the user by way of the dispensing outlet which in the exemplary embodiments is defined by the actuator nozzle. The focus of the present invention is on the construction and use of actuator 24 and ring 26 in order to construct a dispenser with an adjustable stroke for the actuator 24 and in turn provide an adjustable stroke dispenser which allows the end user to select a desired product dosage within a range. The details of actuator 24 are illustrated in FIGS. 6 through 10. The details of ring 26 are illustrated in FIGS. 11 through 15. The details of closure 28 are illustrated in FIGS. 16 through 20.

With reference to FIGS. 6 through 10 and with continued reference to FIGS. 1 through 5, the actuator 24 is illustrated as a single-piece, molded plastic component having a head 56 with a dispensing nozzle 58 which defines the dispensing outlet 60. The head 56 is in unitary construction with body 62 and a generally cylindrical post 64. A hollow passage 66 extends through post 64 and is in flow communication with dispensing outlet 60. As is known in the art and as enabled by the assembled components of FIGS. 1 through 5, the generation of foam (i.e. the flowable product as mixed with air) occurs within the dispenser 20 and is forced up through passage 66 and from there out through nozzle 58 via outlet 60.

Body 62 has a generally cylindrical form and is externally threaded. The series of threads 70 begin adjacent a first edge 72 of body 62 and extend from edge 72 in the direction of head 56 for approximately half of the axial extent of body 62. Formed as a part of body 62 and positioned between threads 70 and head 56 are two sets 74, 76 of annular ribs. Each rib set 74, 76 includes two spaced-apart annular ribs 74a, 74b and 76a, 76b, respectively. The slight separation between each pair of ribs in each set define an annular recessed groove 74c and 76c, respectively. This recessed groove between each pair of ribs provides a detent feature for receipt of a lip portion of ring 26. This detent thus defines a relative axial position for the actuator 24 and ring 26. Other forms of groove may be used; grooves between ribs are convenient for fitting the ring and body together.

As will be described in conjunction with FIGS. 11 through 15, the ring 26 is constructed and arranged to be received by actuator 24. Ring 26 is axially movable relative to actuator 24 in order to adjust stroke length (i.e. the axial travel) of actuator 24. The threads 70 provide an infinitely variable or infinitely adjustable relationship for ring 26 relative to actuator 24, that is, a range of available relative axial positions for the actuator and ring 26. The plural rib sets 74 and 76 provide incremental fixed positions for ring 26 relative to actuator 24, by the axial spacing of the grooves from one another. If the end user prefers a fixed dosage and does not choose to vary the stroke length through threaded engagement and ring travel, either rib set 74 or 76 can be selected. Obviously this fixed position can be easily changed, but if the end-user wants a degree of certainty for the dosage between uses, either rib set can be selected for this purpose.

With continued reference to FIGS. 11 through 15, the structural details ring 26 are illustrated. In the first exemplary embodiment of dispenser 20, the ring 26 is a generally cylindrical, single-piece molded plastic component which is internally threaded. Threads 82 are in engagement with threads 70, see FIGS. 1 through 3. The upper edge 84 of ring 26 is notched in two locations with notches 86 and 88 which are approximately 180 degrees apart. These two notches 86 and 88 provide an alignment or orientation feature for automated assembly. These two notches dictate the facing-forward orientation for ring 26. The upper edge 84 includes a radially-inwardly extending lip 90. Lip 90 has a cross-sectional shape which is tapered on both faces and converges to tip 91 as lip 90 extends radially inwardly. The two notches 86 and 88 also cause lip 90 to be in two arcuate sections 90a and 90b. As would be understood, threaded advancement of ring 26 relative to actuator 24 in either direction results in travel of lip 90 which may either move into engagement with one of the rib sets or may be moved out of engagement with one of the rib sets based on rotation of ring 26 relative to actuator 24 as enabled by their threaded engagement. The actual engagement is with tip 91 being received within the recessed groove of the selected rib set. By configuring each lip section 90a, 90b with a tapered shape on both faces, whether the ring is moving in an upward direction or moving in a downward direction there is the ability for each lip section to detent into one of the recessed grooves 74c or 76c. Forming lip 90 into two sections provides greater flexibility to each section as contrasted to a full circumferential lip.

With reference to FIGS. 16 through 20, the structural details of closure 28 are illustrated. Closure 28 is an annular, single-piece molded plastic component which includes a stem portion 92 and body 94. Body 94 of closure 28 is constructed and arranged with internal threads to thread onto the neck of container 22. Stem portion 92 receives post 64 of actuator 24 and fits inside of body 62 (see FIGS. 1 through 3). There is a reciprocating action enabled by this assembly of closure 28 and actuator 24. As the actuator 24 is depressed in an axial direction toward closure 28, post 64 moves into engagement with air piston 32 (see FIGS. 4 and 5) to initiate the pumping operation of dispenser 20 for the delivery of a dosage of product. In the exemplary embodiments, the product which is within container 22 is dispensed with a foam consistency.

Body 94 has a domed shape with a substantially flat surface 96 or shelf which extends between stem portion 92 and the curved sidewall 98 of body 94. This shelf 96 provides an abutment surface for the lower edge 100 of ring 26 as a way to limit the stroke length (i.e. axial travel) of actuator 24. Although closure 28 has been described as having threaded engagement with the neck of container 22, other forms of assembly, attachment or connection are contemplated. One option would be a snap-on assembly of closure 28 onto container 22. Another option would be a quarter-turn or bayonet connection. The important features are to have a secure connection between closure 28 and container 22 which does not allow any level of liquid leakage which would be deemed unacceptable.

In the assembly of dispenser 20, one of the initial steps is to thread the ring 26 onto actuator 24. The hollow form of ring 26 allows it to be positioned around post 64 and axially advanced toward body 62. Assuming the threads 70 and threads 82 are each properly size and shaped so as to be compatible with each other, threaded engagement is enabled between ring 26 and body 62. The ring 26, as threadedly assembled on to body 62, it is illustrated in three different positions relative to actuator 24 in FIGS. 1 through 3. This threaded engagement securely attaches ring 26 to actuator 24 such that axial movement of the actuator 24 causes a corresponding travel of ring 26. In FIG. 1 ring 26 has been axially advanced onto body 62 to what could be described as a mid-range position between upper and lower limits of travel.

With continued reference to FIG. 1, it will be seen that distance (d) denotes the permitted travel of actuator 24 before there is abutment between the lower edge 100 of ring 26 and shelf 96. As actuator 24 is axially depressed (i.e. downward movement in the direction of container 22), ring 26 which is threadedly secured in the desired position on body 62 moves in unison with actuator 24. A “full” stroke of actuator 24 with the ring 26 in position as illustrated in FIG. 1 is defined by the length of actual travel corresponding to distance (d). Once the lower edge 100 of ring 26 abuts against shelf 96, this indicates to the user that to the selected actuator stroke has been completed. Selection of the desired stroke by the end user of dispenser 20 is based on the positioning of ring 26 relative to actuator 24. There is a tactile feedback to the hand of the user that there is abutment between lower edge 100 and shelf 96 and this abutment signifies the endpoint of travel of the actuator and that it is time to stop any further efforts to depress the actuator 24. Release of the actuator 24 allows it to return to its up position by the action of spring 42 which has been compressed in the process of pushing down on the actuator 24. The axial travel distance of actuator 24 has a direct correlation to the dosage of product. While the actual dosage amount is first influenced by the overall sizing of dispenser 20, container 22 and the sizing and shaping of component parts of the pump arrangement, the ring 26 is used to adjust the dosage amount between a minimum dosage and a maximum dosage. Technically, a minimum dosage would be zero but this simply means no actuator 24 travel. What is intended here in the context of a so-called minimum dosage is that there is some axial travel of actuator 24 and some volume of product is dispensed. This minimum dosage would normally be set based on the type of product being dispensed. For some products the minimum dosage could be fairly modest, such as a minimum dosage for a hand sanitizer product. On the other hand, the minimum dosage might be a little larger for other products, such as for a liquid hand soap. Once the designer of dispenser 20 decides on the desired maximum dosage and on the desired minimum dosage, the dispenser is configured accordingly. Thereafter, ring 26 is used by the end user of dispenser 20 to selectively customize that person's desired dosage at either the maximum dosage or the minimum dosage or somewhere in between those two dosage settings. The use of threaded engagement between ring 26 and actuator 24 enables the end-user to infinitely vary the dosage by adjusting the stroke length, i.e. the actual travel of actuator 24 as controlled by ring 26. What results is an adjustable stroke dispenser wherein varying the stroke varies the dosage.

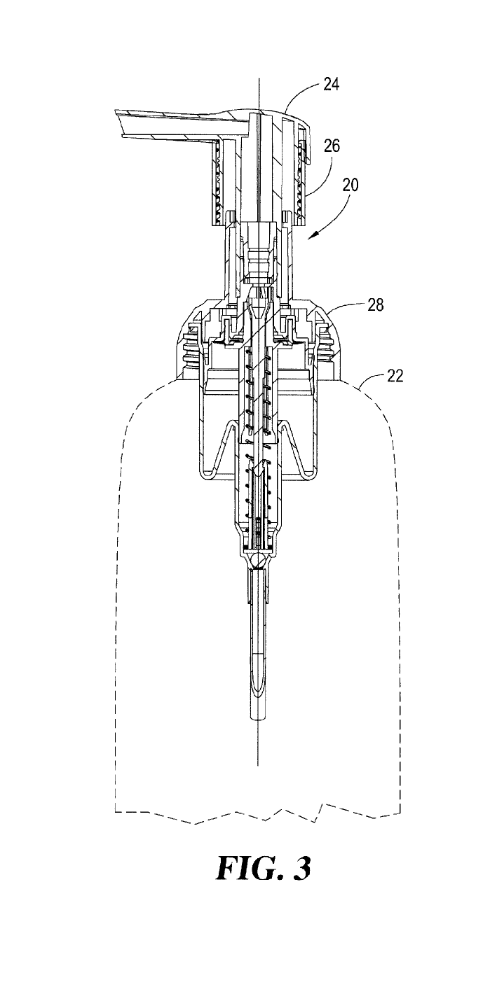

As described and illustrated, the threaded connection between ring 26 and actuator 24 enables the user of dispenser 20 to select any stroke length between the minimum and maximum dosage amounts. Using threaded engagement means that the stroke length is infinitely variable. At the same time, the end user of dispenser 20 has the option of fixing the dosage in one of three levels. By positioning the tip 91 of lip 90 within lower recessed groove 74c (see FIG. 2), the minimum “fixed” dosage is selected. By moving ring 26 all the way up to the underside of head 56 (see FIG. 3) until ring 26 abuts against head 56, the maximum “fixed” dosage is selected. By positioning the tip 91 of lip 90 within upper or intermediate recessed groove 76c (see FIG. 1), a mid-range “fixed” dosage is selected. These three “fixed” dosage settings, in combination with threaded engagement and threaded adjustment, give the end user a dosage selection versatility. The “fixed” positions provide precise repeatability of the dosage. If a threaded adjustment is used to select the dosage, in lieu of one of the three “fixed” positions, the possibility exists that the setting for dispensing a prior dosage might be changed before the next dosage is dispensed. This change in dosage might be the result of another user making a different selection or might be the result of inadvertent rotation of the ring 26 which moves the ring 26 either upwardly (increased dosage) or downwardly (reduced dosage). While a fixed setting could also be changed, there is a greater ability to restore the desired setting of the original user.

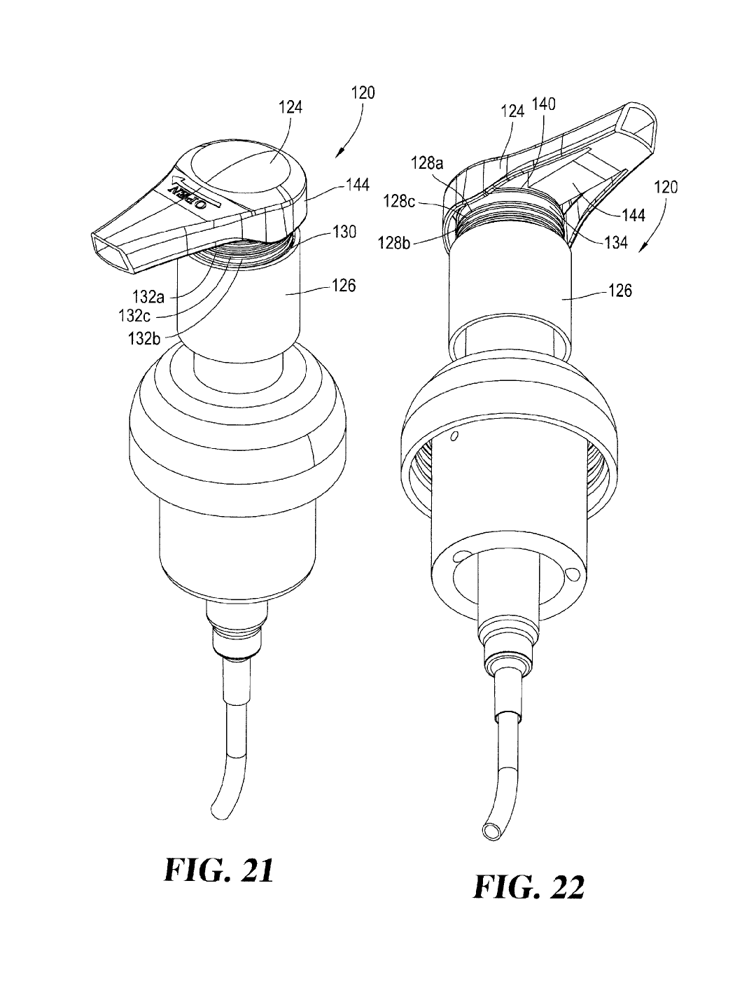

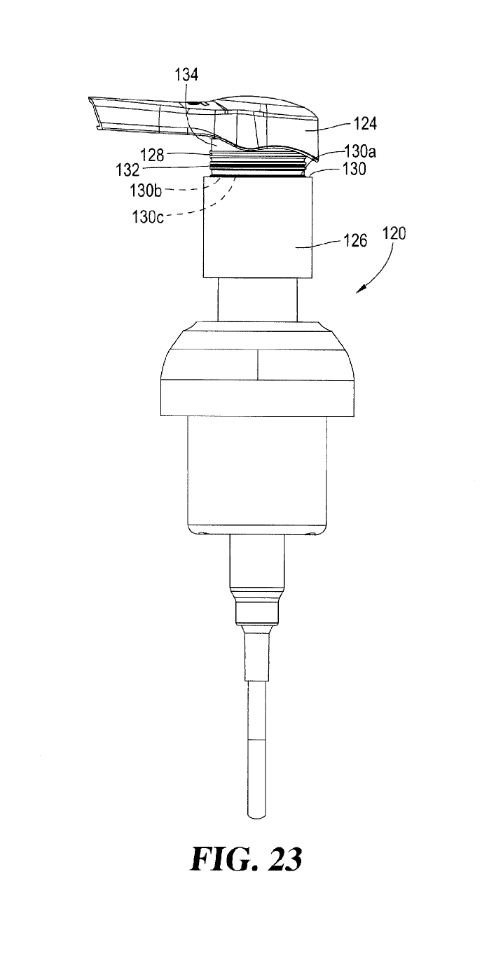

With reference to FIGS. 21 through 29, a second exemplary embodiment is disclosed in the form of dispenser 120. Dispenser 120 is essentially the same as dispenser 20 except for the construction and arrangement of actuator 124 and ring 126. As with the first exemplary embodiment, actuator 124 and ring 126 are each preferably single-piece, molded plastic components. Some of the differences between the first exemplary embodiment of dispenser 20 and the second exemplary embodiment of dispenser 120 include elimination of threads 70 from actuator 124 and elimination of threads 82 from ring 126. Another difference is the addition of a third rib set 128 which includes annual ribs 128a and 128b which defined therebetween annular recessed groove 128c. First and second rib sets 130 and 132 correspond generally to rib set 74 and 76. However, the axial positioning on body 134 of actuator 124 is selected depending on the desired fixed dosages to be provided. Once the axial positions of these rib sets 128, 130 and 132 are set, the actuator stroke length corresponding to each rib set location is also set or fixed. Rib set 130 includes annual ribs 130a and 130b which define therebetween annular recessed groove 130c. Rib set 132 includes annular ribs 132a and 132b which defined therebetween annular recessed groove 132c.

It is to be noted that the use of rib sets provides more of a detent feature for a lip portion of the corresponding ring to snap into so as to fix the position of the ring relative to the actuator by where that ring lip is positioned in terms of which annular recessed groove is selected. Another option, for this type of fixed or stepped adjustment is illustrated in FIG. 30 where the radially inwardly directed lip 222 of ring 226 is a lip segment with a ratchet tooth profile such that its upper surface is substantially flat while its lower surface is tapered. In a corresponding or cooperative manner, actuator 224 includes a series of annular ratchet tooth rings 228 which are arranged in a reverse pattern such that the lower surface of each ratchet tooth ring is substantially flat while the upper surface is tapered. As would be understood, ring 226 is able to move axially in a downward direction relative to actuator 224 such that the ratchet tooth lip 222 merely flexes radially outwardly and then snaps or clicks in below the corresponding ratchet tooth ring 228. As the actuator 224 is depressed in order to engage the corresponding pump arrangement, ring 226 is drawn into abutment against the shelf of the corresponding closure. As the lower edge of ring 226 engages the closure shelf, there might be slight movement of the ring 226 in an upward direction until the upper flat surface of the ratchet tooth lip engages the flat surface of the immediately adjacent ratchet tooth ring. That flat surface-to-flat surface abutment fixes the ring in that position and thereby controls the dosage. The stroke adjustment is permitted by simply sliding ring 226 downwardly relative to actuator 224 so as to cooperate with a different ratchet tooth ring. Movement in the upward direction for ring 226 requires ovalizing of ring 226 so as to allow the ratchet tooth lip 222 to clear the ratchet tooth rings of actuator 224. Once the ring 226 has been moved upwardly to a desired location which essentially defines the selected stroke length, the ovalizing forces can be released and the ring returns to its generally cylindrical form and is therefore able once again to cooperate with one of the ratchet tooth rings 228.

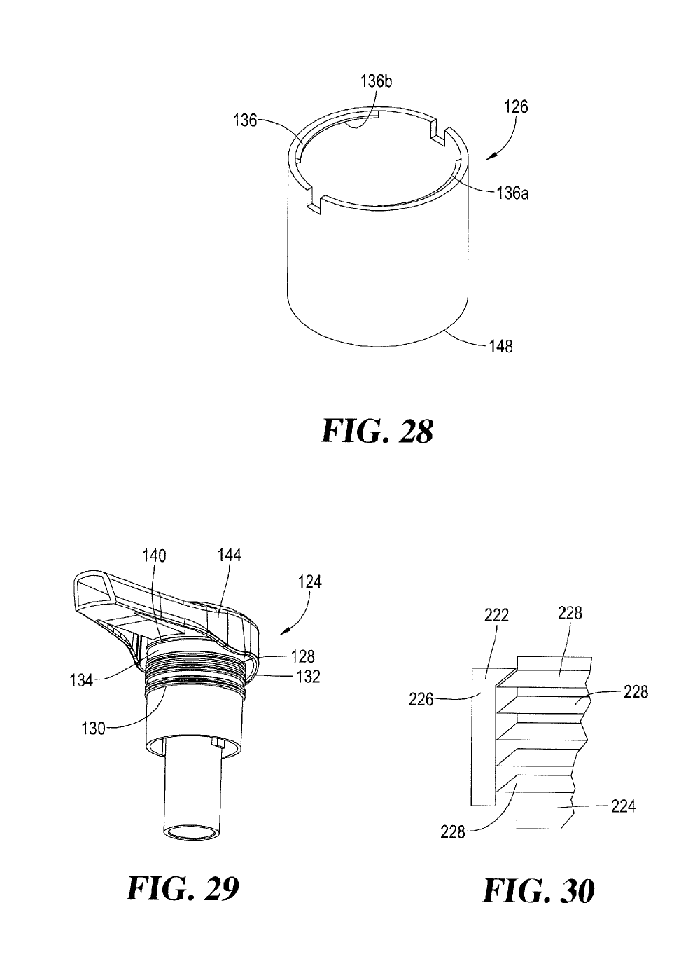

One difference between the two exemplary embodiments (see FIG. 28) includes reducing the circumferential extent of the two lip sections 136a and 136b of lip 136. By creating more circumferential clearance between adjacent ends of lip sections 136a and 136b, it is easier to ovalize ring 126 with sufficient clearance by the application of opposed, inwardly directed sidewall forces (radially inward forces). The intent of such compression ovalizing of ring 126 is to take lip sections 136a and 136b out of engagement with the body of actuator 124. This will be discussed in greater detail herein.

A still further difference between the two exemplary embodiments, though dispenser 20 could optionally include this feature, is the addition of a single annular rib 140 as part of the actuator body 134. Rib 140 is adjacent the underside of actuator head 144 and spaced apart from the actuator head in order to provide clearance for a snap-over receipt of lip sections 136a and 136b. With this construction the ring 126 can be ovalized to free the lip sections 136a and 136b from engagement with any of the first three rib sets 128, 130 and 132 and thereafter axially move the ring 126 to the uppermost position relative to actuator 124 for the maximum actuator stroke length and thus the maximum dosage.

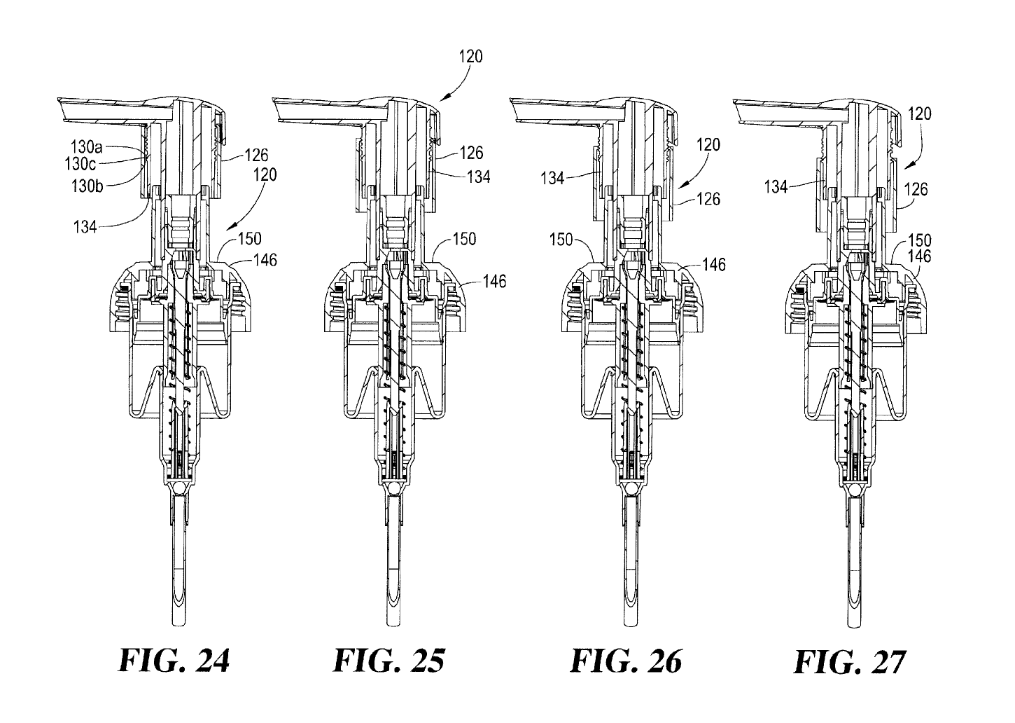

FIGS. 24 through 27 illustrate the position of ring 126 relative to actuator body 134 for four different actuator stroke lengths (i.e. axial travel) and thus four different product dosages. In each illustration the lip sections 136a and 136b of ring 126 are in engagement with the ribs of the actuator body 134. In this second exemplary embodiment the sizing and arrangement of the other components of dispenser 120 provide product dosages of 1.5 cc (FIG. 24), 1.3 cc (FIG. 25), 1.1 cc (FIG. 26) and 0.8 cc (FIG. 27). As with dispenser 20, the extent of actuator travel in an axially downward direction toward closure 146 is determined by the distance between the lower edge 148 of ring 126 and shelf 150 of closure 146. In FIGS. 24 through 27 it will be seen that the indicated dosages correspond to the distance of separation between lower edge 148 and shelf 150. The greater the distance of separation the greater the allowed actuator travel or stroke and the larger the dosage. The adjustable stroke of dispenser 120 is in fixed steps based on the number and location of the rib sets and any single rib adjacent the actuator head 144. Additionally and as already described with regard to FIG. 30, an adjustable stroke for a dispenser according to the disclosed embodiment may also be in fixed steps based upon ratchet tooth engagement involving the ratchet tooth lip 222 of the ring 226 and the series of ratchet tooth rings 228 of actuator 224.

It is important to secure ring 126 relative to actuator 124 and thus the reason for a secure inner fit of each lip section 136a and 136b within the recessed groove of the selected rib set. In the case of the single rib, the underside of the actuator head 144 provides the abutment. When the actuator 24, 124 is advanced for dispensing, the ring 26, 126 travels toward shelf 96, 150, respectively. As abutment of the ring against the shelf occurs, there is a tactile feedback to the user that the intended stroke has been completed. If the ring was allowed to slide upwardly, then the stroke would continue until the ring abuts against the actuator head. Since the objective here is to provide an ability for the user to adjust the stroke, the ring which determines the stroke length needs to be fixed relative to the actuator to the degree that there is sufficient tactile feedback for the user to release the actuator. With regard to the ratchet tooth the arrangement illustrated in FIG. 30, it has been noted that there could be some slight upward travel of ring 226 once there is initial abutment between the lower edge of the ring and the shelf of the closure. The amount or extent of this upward travel is only until the ratchet tooth lip 222 engages the underside surface of the next (upper) adjacent ratchet tooth ring. If the spacing between adjacent ratchet tooth rings 228 is fairly small, then the amount of distance which the ring can travel will also be small.

The structural details of ring 126 are further illustrated in FIG. 28. The structural details of actuator 124 are further illustrated in FIG. 29.

While the invention has been illustrated and described in detail in the drawings and foregoing description, the same is to be considered as illustrative and not restrictive in character, it being understood that only the preferred embodiment has been shown and described and that all changes, equivalents, and modifications that come within the spirit of the inventions defined by following claims are desired to be protected. All publications, patents, and patent applications cited in this specification are herein incorporated by reference as if each individual publication, patent, or patent application were specifically and individually indicated to be incorporated by reference and set forth in its entirety herein.

1. A dispenser for a flowable product comprising:
a pump arrangement;
a movable actuator constructed and arranged to initiate operation of said pump arrangement, wherein the length of the stroke of said movable actuator corresponds to a pump arrangement dosage to be dispensed; and
a ring assembled to said actuator, said ring having a position relative to said actuator which is adjustable, wherein the position of said ring affects the length of the stroke of said movable actuator.

2. The dispenser of claim 1 wherein said ring is assembled to said actuator by threaded engagement.

3. The dispenser of claim 2 wherein said ring is internally threaded and is assembled around a body portion of said actuator.

4. The dispenser of claim 1 wherein said ring includes a lip for detent engagement with said actuator.

5. The dispenser of claim 4 wherein said actuator defines a recessed groove which receives said lip for said detent engagement.

6. The dispenser of claim 5 wherein said actuator includes a rib set which defines said recessed groove.

7. The dispenser of claim 5 wherein said actuator defines plural said recessed grooves at different axial positions.

8. The dispenser of claim 1 wherein said ring includes two lip sections of said lip which are separated from each other by clearance spaces.

9. The dispenser of claim 8 wherein said ring is constructed and arranged to be ovalized by the application of compressive forces in order to disengage said two lip sections from said detent engagement.

10. The dispenser of claim 1 wherein said pump arrangement includes a closure.

11. The dispenser of claim 10 wherein said actuator stroke moves said ring in the direction of said closure.

12. The dispenser of claim 11 wherein abutment between said ring and said closure provides tactile feedback denoting the end of the stroke.

13. The dispenser of claim 1 which includes a closure as a part of said pump arrangement and wherein the position of said ring relative to said actuator determines the actuator stroke length until there is ring to closure abutment.

14. The dispenser of claim 1 wherein the ring includes a inner-facing ratchet tooth lip selectively engaging the actuator between a pair of ratchet tooth rings at least partially disposed on an outer circumference of the actuator proximate to the ring.
